(19) United States
(12) Patent Application Publication
(10) Pub. No.: US 2007/0027036 A1
(43) Pub. Date: Feb. 1, 2007

(54) Variable density drilling mud

(76) Inventors: Richard S. Polizzotti, Milford, NJ (US); Mehmet D. Ertas, Hillsborough, NJ (US); Norman M. Pokutylowicz, Hillsborough, NJ (US); Scott T. Milner, Somerville, NJ (US); James R. Rigby, Kingwood, TX (US); John Montgomery, Houston, TX (US); Pavlin B. Entchev, Houston, TX (US); Stuart R. Keller, Houston, TX (US); Vishwas Gupta, Stafford, TX (US); William J. Sisak, Houston, TX (US)

Correspondence Address: FISH & NEAVE IP GROUP;ROPES & GRAY LLP, 1251 AVENUE OF THE AMERICAS FL C3, NEW YORK, NY, 10020-1105, US

(21) Appl. No.: 11/441,698

(22) Filed: May 25, 2006

Related U.S. Application Data
(63) Continuation of application No. PCT/US05/20320, filed on Jun. 9, 2005.
(60) Provisional application No. 60/580,523, filed on Jun. 17, 2004.

(51) Int. Cl. C09K 8/02

(52) U.S. Cl. 507/143

(57) ABSTRACT

One embodiment of the invention is a variable density drilling mud comprising compressible particulate material in the drilling mud wherein the density of the drilling mud changes in response to pressure changes at depth. A second embodiment is a method for varying drilling mud density. The method comprises estimating the pore pressure and fracture gradient, and choosing a drilling mud with compressible materials wherein the effective mud weight of the drilling mud remains between the pore pressure and the fracture gradient in at least one interval of the wellbore. A third embodiment is an apparatus for drilling a wellbore.

### RELATED APPLICATIONS

This application claims priority to U.S. Application No. 60/580,523 filed Jun. 17, 2004.

### FIELD OF THE INVENTION

This patent generally relates to subterranean wellbores. More particularly, this patent relates to drilling mud and a method and apparatus for minimizing or eliminating the need for casing the wellbore.

### BACKGROUND

Conventionally, when a wellbore is created, a number of casings are installed in the wellbore to prevent collapse of the wellbore wall and to prevent undesired outflow of drilling fluid into the formation or inflow of fluid from the formation into the wellbore. The wellbore is typically drilled in intervals whereby a casing (such as, steel pipe), which is to be installed in a lower wellbore interval, is lowered through a previously installed casing of an upper wellbore interval. As a consequence of this procedure, the casing of the lower interval is of smaller diameter than the casing of the upper interval. Therefore, the casings are in a nested arrangement with casing diameters decreasing in the downward direction. Cement annuli are typically provided between the outer surfaces of the casings and the wellbore wall to seal the casings from the wellbore wall and prevent flow from lower intervals from going between the wellbore wall and back side of the casings.

In most wells, the most critical role of the casing/cementing system is to increase the minimum fracture gradient to enable continued drilling. Generally, when drilling a well, the pore pressure gradient (PPG) and the fracture pressure gradient (FG) increase with the true vertical depth (TVD) of the well. Typically for each drilling interval, a mud density (mud weight or MW) is used that is greater than the pore pressure gradient, but less than the fracture pressure gradient.

As the well is deepened, the mud weight is increased to maintain a safe margin above the pore pressure gradient. If the mud weight were to fall below the pore pressure gradient, the well may take a kick. A kick is an influx of formation fluid into the wellbore. Kicks can result in dangerous situations and extra well costs to regain control of the well. If the mud weight is increased too much, the mud weight will exceed the fracture pressure gradient at the top of the drilling interval (usually this is the location with the smallest fracture pressure gradient). This normally leads to lost returns. Typically, lost returns occur when the drilling fluid flows into a fracture (or other opening) in the formation. Lost returns results in large volumes of mud loss, which is costly in terms of fluid replacement and operational time to treat and replace lost returns. Lost returns also lower the bottom hole pressure of the wellbore, which can lead to a kick. Additionally, lost returns results in the cuttings not being removed from the wellbore. The cuttings may then accumulate around the drill string causing the drill string to become stuck. A stuck drill pipe is a difficult and costly problem that often results in abandoning the interval or the entire well.

To prevent the above situation from occurring, conventional practice typically involves running and cementing a steel casing string in the well. The casing and cement serve to block the pathway for the mud pressure to be applied to the earth above the depth of the casing shoe. This allows the mud weight to be increased so that the next drilling interval can be drilled. This process is generally repeated using decreasing bit and casing sizes until the well reaches the planned depth. The process of tripping, running casing, and cementing may account for as much as 25 to 65 percent of the time required for drilling a well. Tripping is the process of pulling the drill pipe or running the drill pipe into the well. Because well costs are primarily driven by the required rig time to construct the well, these processes may increase the cost of drilling the well. Furthermore, with the conventional steel casing tapered-hole-drilling process, the final hole size that is achieved may not be useable or optimal and the casing and cement operations substantially increase well costs.

As a consequence of this nested arrangement, relatively large wellbore diameters are required in the upper part of the wellbore. Such large wellbore diameters involve increased costs due to the time to drill the holes, the time to install all of the casings, costs of casing, and drilling fluid consumption. Moreover, increased drilling rig time and costs are involved due to required tripping drill pipe out, cement pumping, cement hardening, required equipment changes due to variations in hole diameters drilled in the course of the well, tripping drill pipe in, and the large volume of cuttings drilled and removed.

For exploration wells, the reduction in hole size with increasing depth may result in not reaching the planned target depth or not reaching the planned target depth with enough hole size to run logging tools to fully evaluate the formation. Typically, at least a 0.1524 meter (6-inch) open hole is needed to fully evaluate the formation. For some wells, the need to set casing to accommodate pore pressure/fracture gradient concerns results in running out of hole size. For development wells, the telescopic nature of the well reduces the final hole size in the reservoir. This reduction in the contact size of the well with the reservoir may reduce the production rate of the well, thereby, reducing the well's performance. Generally, a larger hole size in the reservoir increases the well's production rate for a given drawdown. Drawdown is the difference between the fluid pressure in the reservoir and inside the well.

Current technologies used to address the problems discussed above, especially in deepwater wells, include the use of a dual (or multiple) gradient drilling system. For example, U.S. Pat. No. 4,099,583 discloses a dual gradient drilling system. In this method, a lighter fluid is injected into the mud return annulus (typically in the riser) or other pathway to reduce the mud density from the injection point upwards. This helps tailor the mud pressure gradient profile to closer match the desired pressure gradient profile that is between the pore pressure gradient and fracture gradient profiles. Multiple gradient drilling systems may reduce the required number of casing strings by possibly one or two. However, these systems are mechanically complex, are very costly to implement, create operational concerns (for example, for well control), and still result in a tapered wellbore.

U.S. Pat. No. 6,530,437 and U.S. Pat. No. 6,588,501 disclose a multi-gradient drilling method and an apparatus for reduction of hydrostatic pressure in sub sea risers. For example, in Mauer et al., rigid hollow spheres are injected into the flowing mud at discrete locations in the riser and in the borehole below the mud line. This permits stepwise reduction in the effective mud density above the point of injection. Furthermore, this approach can in principle be used to stepwise change the mud density in the return annulus in such a way as to keep the mud weight between the pore pressure gradient and the fracture gradient.

To accomplish this, multiple injection points at different vertical positions within the annulus would be needed. The vertical position of these injection points would also need to be adjusted to accommodate unanticipated deviations in the pore pressure and fracture gradients. This stepwise reduction in mud density can at best only reduce the number of intermediate casing strings required by the number of injection points added. These systems, like conventional multi-gradient systems, are mechanically complex, are very costly to implement and create operational concerns (for example, for well control).

A series of U.S. patents assigned to Actisystems of Edmond OK disclose the addition of various fluid aphrons to drilling mud formulations. See, for example, U.S. Pat. No. 6,422,326, U.S. Pat. No. 6,156,708, U.S. Pat. Nos. 5,910,467 and 5,881,826. The fluid aphrons reduce the density of the mud and reduce the lost circulation potential of the mud. Liquid aphrons are oil in water emulsions with a high oil/water volume ratio and are 5-20 microns in size. A small volume of this emulsion is dispersed into the drilling mud to form colloidal liquid aphrons (CLA). In this way a very large interfacial area is created without large power input. Colloidal gas aphrons (CGA) are microbubbles 10-100 microns in diameter coated with multiple layers of surfactant and created by shearing the liquid above some critical shear rate. The use of gas aphrons does not provide the desired object compression that reduces the number of required intermediate casing strings.

Another technology used to address some of problems discussed above is the use of solid expandable liners (SELs). An example of a solid expandable liner is disclosed in U.S. Pat. No. 6,497,289. Solid expandable liners are special tubular systems that are run into a well and expanded. The expansion allows the open hole to be lined using a string that has a larger interior diameter than would otherwise be available with a conventional liner. The solid expandable liner system allows a larger bit and/or additional casing strings to be run in the well. In development wells, this can facilitate penetrating the reservoir with a larger wellbore size. For exploration wells, having one or two additional liners may enable the well to reach a planned target with a useable wellbore size. While some aspects of a solid expandable liner may be beneficial, it has several drawbacks. These include time and cost, connections, hole quality requirements, tapering, and cementing. However, a solid expandable liner cannot reduce the number of required casing strings.

Accordingly, there is a need for improved drilling mud to minimize or eliminate the need to install casings or linings inside a wellbore that addresses the above-mentioned drawbacks of current casing techniques. This invention satisfies that need.

### SUMMARY

One embodiment of the invention is a variable density drilling mud. The drilling mud comprises compressible particulate material in the drilling mud wherein the density of the drilling mud changes in response to pressure changes.

A second embodiment is also disclosed. This embodiment is a method for varying drilling mud density. The method comprises estimating the pore pressure and fracture gradient, and choosing a drilling mud with compressible material wherein the effective mud weight of the drilling mud remains between the pore pressure and the fracture gradient in at least one interval of a wellbore.

A third embodiment is also disclosed. This embodiment is an apparatus for drilling a wellbore. The apparatus comprises a drill string with a bottom hole assembly and a drill bit on the bottom hole assembly, and means to pump variable density mud into the wellbore to maintain the mud pressure in the wellbore between the pore pressure gradient and the fracture gradient. In one embodiment, the means to pump the variable density drilling mud is a mud pump that pumps the mud down the drill string through the drill bit and back up the annulus between the drillstring and the wellbore.

### BRIEF DESCRIPTION OF THE DRAWINGS

FIG. 1 is an illustration of a typical well planning diagram;

FIG. 2 is an exemplary flow chart in accordance with an embodiment of the present techniques;

FIG. 3 is a comparative illustration between a typical well planning diagram and a well planning diagram using in accordance with an embodiment of the present techniques;

FIG. 4 is an exemplary phase diagram of stress versus temperature for a shape memory alloy in accordance with an embodiment of the present techniques;

FIG. 5 is an exemplary diagram of stress versus strain for the shape memory alloy of FIG. 4 in accordance with an embodiment of the present techniques;

FIG. 6 is an exemplary diagram of pressure versus depth for a compressible hollow particle made of shape memory alloys in accordance with embodiments of the present techniques; and

FIGS. 7A and 7B are exemplary diagrams of volume versus pressure for compressible and collapsible particulate materials in accordance with embodiments of the present techniques.

### DETAILED DESCRIPTION

In the following detailed description and example, the invention will be described in connection with its preferred embodiments. However, to the extent that the following description is specific to a particular embodiment or a particular use of the invention, this is intended to be illustrative only. Accordingly, the invention is not limited to the specific embodiments described below, but rather, the invention includes all alternatives, modifications, and equivalents falling within the true scope of the appended claims.

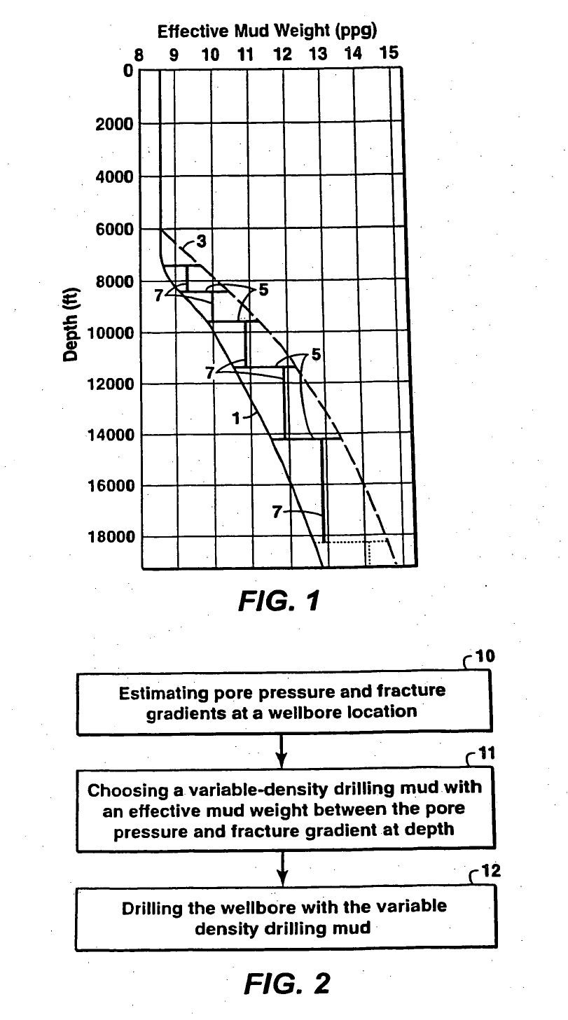

FIG. 1 is an illustration of a typical pore pressure gradient curve 1 and fracture gradient curve 3 with a depiction of conventional casing setting points 5. The mud weights 7 are set for a given casing setting point to be above the pore pressure gradient curve 1 but below the fracture gradient curve 3. The casing setting points 5 permit increased open-hole minimum fracture gradients so that higher mud weight can be used in the wellbore.

We have discovered that we can tailor the drilling mud density with depth so that the effective mud weight remains between the pore pressure and the fracture gradient at all depths. We have further discovered that the required variation in mud density can be achieved with the addition of particulate component whose density is substantially different from that of the remaining fluid and whose volume (and therefore density) changes in response to pressure. The particulate components may include various shapes, such as spheres, cubes, pyramids, oblate or prolate spheroids, cylinders, pillows and/or other shapes or structures. Further, the particulate components may be compressible hollow objects, which are filled with pressurized gas, or even compressible solid materials or objects, as described further below.

One embodiment is a method for varying the density of drilling mud in a wellbore at a chosen location. As shown in FIG. 2, the pore pressure and fracture gradients are estimated at the wellbore location 10. A variable density drilling mud is chosen to achieve an effective mud weight between the pore pressure and fracture gradient preferably at all depths 11, but in at least one interval of the wellbore. The wellbore may then be drilled using the variable density drilling mud 12.

In one embodiment, the variable density drilling mud comprises particulate materials such as, compressible (or collapsible) hollow objects. More preferably, the compressible hollow objects would have a relatively small diameter and be gas pressurized, (for example, spheres, oblate or prolate spheroids, cylinders, pillows or any other suitable shape). The material would be chosen to achieve a favorable compression in response to pressure changes. Examples of suitable materials include but are not limited to polymer, polymer composites, metals, metal alloys, and/or polymer or polymer composite laminates with metals or metal alloys.

Preferably, only one drilling mud design would be necessary. In this scenario the particulate material would be tailored to provide a drilling mud density change at depth that would permit one drilling mud design to maintain a drilling mud pressure between the pore pressure gradient and fracture gradient throughout the wellbore. If the drilling mud design cannot maintain a mud pressure between the pore pressure gradient and fracture pressure gradient, additional casing may be added as necessary. Preferably, the particulate material in the variable density drilling mud is chosen to have a favorable density change at depth wherein the drilling mud pressure is maintained between the pore pressure gradient and the fracture pressure gradient with the least number of casings

The initial internal pressure of the hollow object may be selected based on the depth at which a transition in the compressibility is desired. At depths in the mud column for which the pressure is below the initial internal pressure, the mechanical properties of the shell material, such as Young's Modulus, and the differential pressure across the shell control the volume change of the objects. At depths for which the pressure in the mud column is above the initial internal pressure, the volume change of the hollow objects gradually becomes dominated by the compressibility of the gas if the differential pressure across the wall exceeds the collapse pressure of the hollow objects.

The compression of these hollow objects results in a different gradient of mud density above and below the depth defined by the initial internal pressure of the hollow objects. Mixing objects of different initial internal pressure and changing the volume fraction and distribution of initial pressures as the depth of the well increases can achieve the desired result of maintaining the mud pressure between the required bounds.

The hollow objects may be partially filled with a liquid, mixtures of condensable and non-condensable gases, or any combination thereof. Addition of a condensable gas or liquids allows additional flexibility in tailoring the variation of mud density with depth. For instance, at the temperature and pressure of the gas/liquid phase boundary the condensable gas liquefies with an increase in density and a corresponding decrease in volume. The decrease in internal volume of the object will result in a step increase in effective mud density at the depth and temperature corresponding to the phase transition. An additional potential benefit of using a gas mixture containing a condensable gas is the finite internal volume occupied by the condensed gas at depths greater than that at which it condenses. Because the compressibility of liquids is generally lower than that of the non-condensable gas, the liquid volume can be used to set an upper limit on the deformation experienced by the wall of the hollow object. This may assist in controlling the fatigue life of the flexible objects as they cycle between the bottom of the hole and the surface.

Confining the volume change to a large number of small diameter objects mixed into the remaining mud fluid allows tailoring of the initial size and shape of the objects, to achieve the desired rheology of the composite mud system. Both the gel point of the mud and the variation of the mud viscosity with shear rate are altered by the addition of a large volume fraction of the proposed compressible objects to the mud. The initial properties of the fluid phase are preferably chosen such that the resulting composite mud gel point is sufficient to suspend the rock cuttings in the annulus during normal operations, including non-circulating operations. Furthermore, the viscosity of the composite mud satisfies pumpability requirements without developing unacceptable dynamic pressure gradients in the annulus. This is facilitated by the fact that both the gel point alteration and the modification of the composite mud viscosity with shear rate exhibit similar functionality for compressible object volume fraction loading of up to 45 percent.

In the case of a spherical hollow shell, the tensile strength of the materials required is defined by the relationship:
T=(pr)/2 h. (1)

Wherein:

T is the tensile strength,

p is the internal pressure,

r is the radius of the sphere, and

h is the wall thickness of the spherical shell.

For a sphere of diameter 1.0 mm (millimeter) with an internal pressure of 13.8 Mpa (mega pascals) (2000 psig (pounds per square inch gauge)) and a wall thickness of 0.125 mm, the yield strength of the material required would be T=27.6 Mpa (40,000 psi). Many common materials have a yield strength that meets or exceeds the required level.

A greater potential issue is the effective lifetime of the pressurized spheres due to gas leakage through the wall. In the case of the crystalline polymer PEEK the gas permeation rate for oxygen for a differential pressure of 1 Bar is approximately 852.5 cm³/day m²(centimeter³/day/meter²) for a 100 micron thick wall at 25° C. (Celsius). The initial volume of gas in a 1-mm internal diameter sphere at 136 atmospheres is only 0.071 cm³ at standard temperatures and pressure (STP). The leak rate for such a sphere is then approximately 0.0152 cm³/hr (centimeter³/hour) and the sphere would lose approximately 2.95 Mpa (428 psi) of the initial 13.8 Mpa (2000 psi) charge in one hour and would have a useful lifetime of less than one hour. Therefore, it may be advantageous to reduce the gas permeation rate if a polymer shell is to be useful for the purpose of this invention.

We have devised several options to reduce the permeation rate and to create a material with a substantially low permeability. The spheres can be made larger with thicker walls than the current example. For example, at a given h/r ratio, the lifetime will increase as the square of the sphere radius. The spheres can be filled with gases with large molecular volumes, such as SF₆ (sulfur hexa-flouride) that possess intrinsically low diffusion rates. SF₆ has a diffusion constant approximately 100 smaller than CO₂ (carbon-dioxide) in polymer membranes. The wall of a polymer sphere could be filled with particulate such as exfoliated clay particles to act as barriers to gas permeation.

Alternatively, the walls of the hollow objects may be made of metals, laminates of polymer and thin metal films, or any other material with sufficient tensile strength and suitably low gas permeability. In the case of metal films and metal/polymer laminates, literature data suggests that both the strength and permeability of many common metals and polymer/metal laminates are more than adequate to satisfy both the strength and permeability requirements for the proposed application.

In one embodiment, it is envisioned that the compressible solid objects are continuously re-circulated with the flowing mud. In this embodiment, the compressible objects may be passed directly through the mud pumps at the surface down the drill string, through the drill bit and back up the annulus between the drill string and the wellbore. If necessary, an additional separation step may be performed at the surface to separate the compressible objects from the cuttings and reconstitute the composite mud prior to re-injection. The large density difference between the compressible objects and the cuttings may greatly facilitate any separation that is required.

In an embodiment the re-injection of the objects would occur down stream of the mud pumps. Methods for continuously injecting rigid spheres into a flowing mud stream and for separation of rigid spheres from the mud have already been disclosed in the patent literature. See for example, U.S. Pat. Nos. 6,530,437 and 6,588,501.

Similarly, if it is undesirable to pass the compressible objects through the high shear jets at the drill bit, the compressible objects can be shunted around the bit. One method to accomplish this would be to use a downhole centrifugal separator just above the BHA (Bottom Hole Assembly) in the drill string with a side injection port just above the BHA to shunt the spheres into the return annulus bypassing the high shear zone at the cutting face.

Other anticipated and unanticipated benefits may result from the addition of flexible pressurized hollow objects to the mud composition. For example, addition of these objects may reduce friction between the rotating drill string and the wall. The relevant prior art includes for example, U.S. Pat. No. 4,123,367. In this patent, a method for reducing drag and torque on a rotary drill string by the addition of minute spherical solid glass beads to the mud is disclosed.

The addition of flexible pressurized hollow objects to the mud composition may also in part mitigate lost returns. In a lost returns situation, the partially compressed hollow objects re-circulating with the mud will enter the fault along with the mud flow. As they enter the formation fault, the objects are expected to expand as they move from the higher-pressure wellbore into the lower-pressure of the formation fault. We expect the objects will become lodged in the fault helping to seal the formation. The flexibility of the objects is also expected to assist in formation of a more effective seal. Relevant prior art includes for example, U.S. Pat. No. 4,836,940. This patent discloses the addition of a pelletized composition comprising a water insoluble, water absorbent polymer and bentonite. In this concept, the pellets enter the formation fault where they become trapped. The trapped pellets slowly absorb water swelling and sealing the formation.

### EXAMPLE

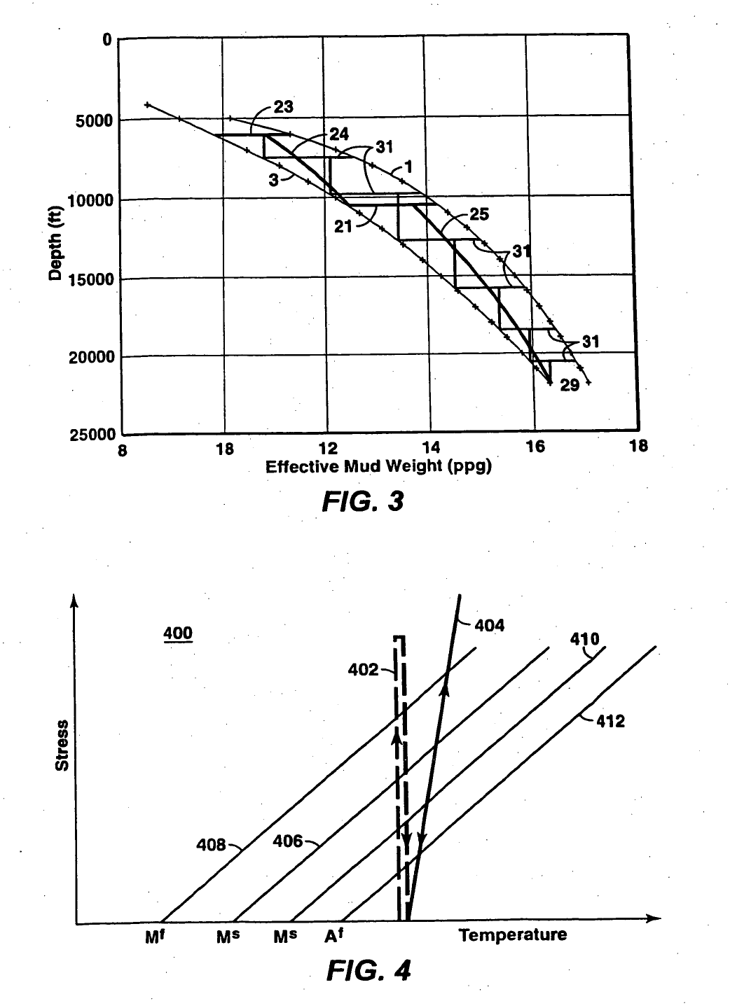

An example of the application of this concept to hypothetical deep water well drilled to a final depth of 22,000 feet is illustrated below. FIG. 3 is a graph comparing conventional casing design using fixed density drilling mud and variable density drilling mud designs.

In the example illustrated in FIG. 3, the number of required intermediate casing strings 21 is reduced from six to just one. The surface casing 23 at approximately 6,000 feet is required to support the weight of the sub-sea equipment and/or for regulatory compliance and thus cannot be eliminated. The reduction in the number of required casing intervals are achieved by using two variable density mud compositions as shown in the figure. As can be seen from FIG. 3, with these two compositions, the mud weight remains well within safe limits between the fracture gradient 1 and the pore pressure gradient 3 for the entire drilled interval.

The first drilling mud 24 composition allows the wellbore to be drilled from the surface casing 23 to the intermediate casing 21. The second drilling mud 25 composition allows the wellbore to be drilled to the target depth 29 without any additional casing. This planning diagram, without the variable density drilling mud would require 6 intermediate casings 31. Reducing the additional casings after the surface casing form 6 to 1 reduces well costs.

There are several benefits that may be associated with the application of the present techniques. First, the embodiments of the present techniques provide a method of changing the architecture of a well. That is, the present technique eliminates the plateau time associated with setting certain casing strings because the particulate material in the variable density drilling mud reduces the number of changes in the casing strings. Accordingly, the use of variable density drilling mud may allow drilling activities to reach reservoirs at greater depths by overcoming the limitations and restrictions imposed by conventional drilling operations, as noted above. Second, the embodiments of the present techniques reduce the costs associated with accessing reservoirs. In particular, the reduction in the size and cost of the drilling vessel and pumps required because the size of the wellbore may be substantially reduced. Further, the variable density drilling mud may reduce the material costs, such as drill bits, risers, casing, cement and mud. As such, the use of the variable density drilling mud with the particulate materials in a well may reduce the costs associated with accessing a reserve and provide justification to access certain reservoirs.

In another embodiment, the particulate materials, which include the compressible (i.e. collapsible or deformable) hollow particles, may be made of shape memory alloys (SMAs). As described in greater detail in FIGS. 4-7B, shape memory alloys are metallic alloys that undergo a solid-to-solid phase transformation and may recover their shapes from large strains. As such, the compressible or deformable hollow particles or objects may be made of shape memory alloys having relatively small diameters and may be utilized to provide variations in the density of drilling muds.

To begin, the shape memory alloys rely upon pressure (i.e. applied stress load to the shape memory alloy) and temperature to determine the phase of the shape memory alloy. These phases include an austenite phase and a martensite phase. As shown in FIG. 4, an exemplary phase diagram of stress versus temperature for a shape memory alloy in accordance with an embodiment of the present techniques is illustrated. In this diagram, which may be referred to by reference numeral 400, the shape memory alloy is characterized by four temperatures, which impact the different phases of the shape memory alloy. These temperatures include martensitic start (M^{s}), martensitic finish (M^{f}), austenitic start (A^{s}) and austenitic finish (A^{f}).

Because the temperatures influence the phase of the shape memory alloy, adjustments in the stress or pressure with respect to the temperature may define various phase regions for the shape memory alloy. That is, the phase of the shape memory alloy depends on the previous phase along with the pressure and temperature to determine the phase region. In these different regions, the shape memory alloy has different behavioral characteristics, such as superelasticity, which may also be referred to as pseudoelasticity. The superelastic characteristic is observed along an isothermal superelastic loading path 402 and a non-isothermal superelastic loading path 404. On the isothermal superelastic loading path 402, the temperature remains constant as the stress is increased (i.e. loaded) and decreased (i.e. unloaded). On the non-isothermal loading path 404, the temperature increases as the stress increases, which may be representative of loading the compressible hollow shape memory alloy particles inside a wellbore. That is, the non-isothermal loading path 404 represents the stress and temperature experienced by shape memory alloys as the depth in the wellbore increases.

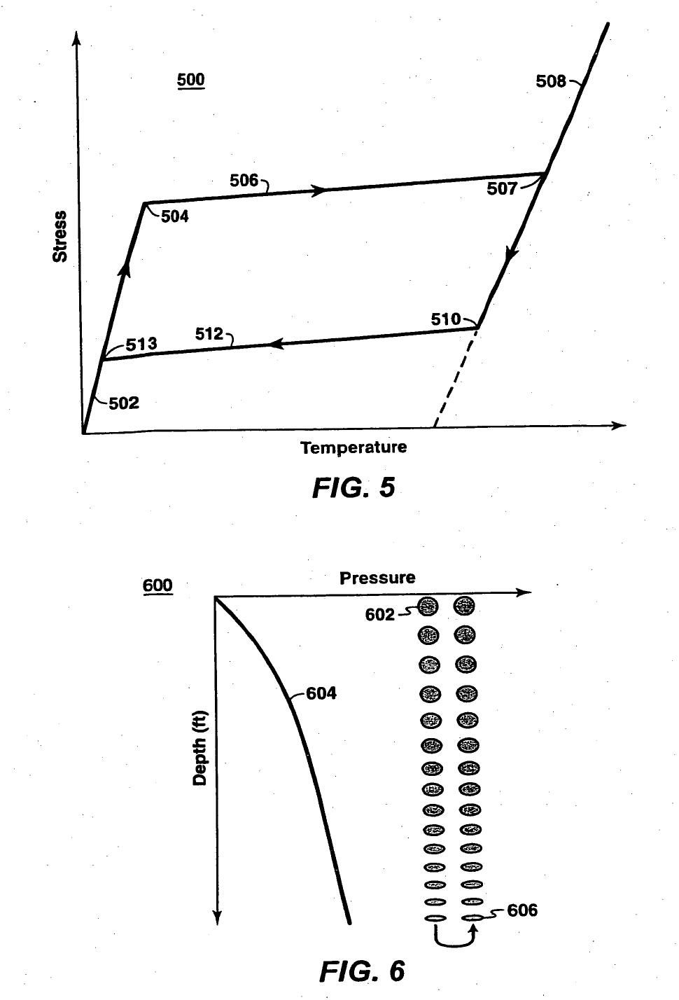

Accordingly, these different phase regions of the shape memory alloys may be best understood with reference to the paths 402 and 404. With each of the paths 402 and 404, the shape memory alloy is in the austenite phase when the temperature and stress are below the martenstic start line 406. Between the martenstic start line 406 and the martenstic finish line 408, the shape memory alloy is in an austenitic-to-martenstic transformation region. Above the martenstic finish line 408, the shape memory alloy is in the martensite phase. As such, any additional loading of pressure or stress maintains the shape memory alloy in this region. Alternatively, as the loading is decreased, the shape memory alloy remains in the martensite phase as long as the shape memory alloy is above the austenitic start line 410. Between the austenitic start line 410 and the austenitic finish line 412, the shape memory alloy is in the martenstic-to-austenitic transformation region. Then, below the austenitic finish line 412, the shape memory alloy is in the austenite phase. The transformation of the shape memory alloy is further described in FIG. 5.

FIG. 5 is an exemplary diagram of stress versus strain for the shape memory alloy of FIG. 4 in accordance with embodiments of the present techniques. In this diagram, which may be referred to by reference numeral 500, the stress versus strain response resulting from superelastic loading is schematically illustrated as three distinct phases, which are the martensite phase, austenite phase, and transformation phase. The transformation phase includes the conversion from martensite-to-austenite phase and the conversion from austenite-to-martensite phase. The amount of recoverable transformation strain may depend on the composition and treatment of the shape memory alloy. These shape memory alloys may include Nickel-Titanium (NiTi), Copper-Aluminum-Zinc (CuAlZn), Nickel-Titanium-Copper (NiTiCu), Copper-Aluminum-Nickel (CuAlNi), and any other suitable metal alloy. Typically, the amount of recoverable transformation strain for these shape memory alloys may range between about 3% to about 8%.

During the loading process, the shape memory alloy behaves in an elastic manner, as shown in the austenite elastic line 502. When a first stress level or collapse threshold is reached, as shown by first point 504, the transformation stage begins. The first collapse threshold may be a point along the martenstic start line 406 of FIG. 4 that corresponds to a specific temperature. As the loading continues to increase, the transformation strains are generated during conversion of the shape memory alloy from the austenite phase to the martensite phase, as shown by first transformation line 506. Then, the transformation to the martensite phase is complete at the second point 507. When the shape memory alloy has transformed into the martensite phase, as shown by the martensite elastic line 508, the shape memory alloy behaves in an elastic manner of the martensite phase.

During the unloading process, the shape memory alloy again behaves in an elastic manner that is consistent with the martensite phase, as shown in the martensite elastic line 508. When a second stress level or collapse threshold is reached, as shown by third point 510, the reverse transformation stage begins for the conversion from martensite-to-austenite phase. The transformation phase may again be entered by unloading the stress on the shape memory alloy, as shown by second transformation line 512. As the stress on the shape memory alloy is reduced, the shape memory alloy may reform into its previous structure. Then, the transformation to the austenite phase is complete at the fourth point 513. When the shape memory alloy has transformed into the austenite phase, as shown by the austenite elastic line 502, the shape memory alloy behaves in an elastic manner of the austenite phase. The transformation of the shape memory alloy is further described FIG. 6 below.

FIG. 6 is an exemplary diagram of pressure versus depth for a compressible and/or deformable hollow object made of shape memory alloy in accordance with embodiments of the present techniques. In this diagram, which may be referred to by reference numeral 600, the compressible particulate material may be made of shape memory alloy that converts between the austenite and martensite phases. Based on this compressibility provided in the conversion, the hollow shape memory alloy particles adjust their size to vary the effective weight of the drilling mud.

To begin, an austenite shape memory alloy particle 602 may have the structure of a sphere, as one example. As the austenite shape memory alloy particle 602 is transported down within the wellbore, and the pressure external to the austenite shape memory alloy 602 increases, as shown by the line 604. Accordingly, as the pressure and stress exceed the stress or collapse threshold, such as the first point 504 of FIG. 5, the austenitic-to-martensitic transformation begins. As a result, because the shape memory alloy particle is a compressible hollow object, the shape memory alloy particle collapses to form the martensitic shape memory alloy 606. In the collapsed form, the effective mud weight has increased to the largest value for the specific shape memory alloy.

Once the martensitic shape memory alloy particle 606 is directed to move up the wellbore, the martensitic shape memory alloy particle 606 may retain its shape until the martensitic shape memory alloy particle 606 reaches a point where the surrounding hydrostatic pressure and temperature is less than the collapse or stress threshold, such as the third point 510 of FIG. 5. At this collapse threshold, the reverse transformation from martensite-to-austenite phase initiates and the shape memory alloy particle starts to recover its shape. Thus, when the austenite shape memory alloy particle 602 reaches the surface of the wellbore, the effective mud weight is at its lowest level. Accordingly, the different phases of the shape memory alloy are utilized to adjust the effective weight of the drilling mud.

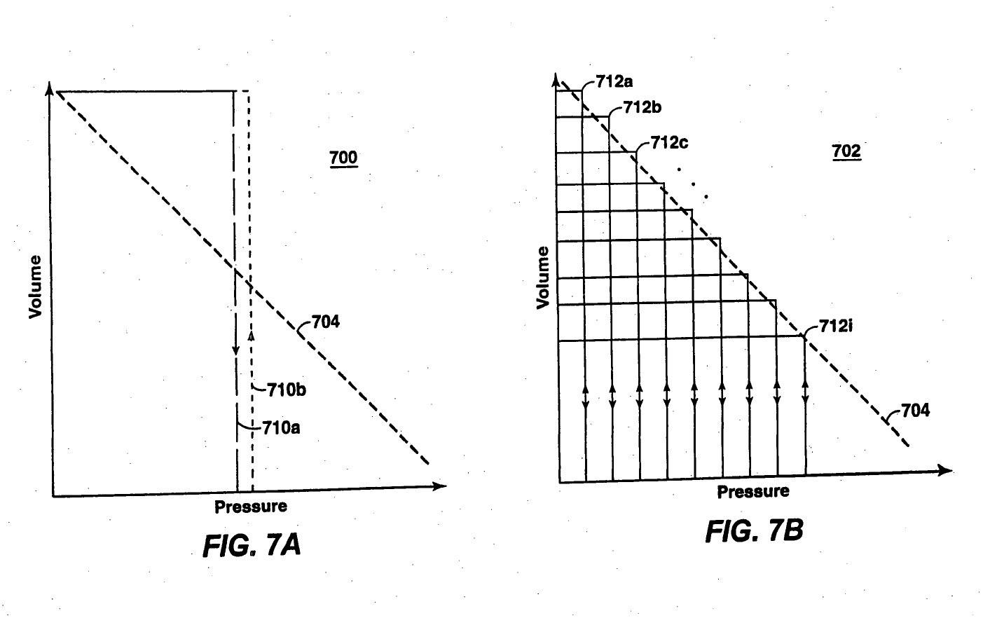

FIGS. 7A and 7B are exemplary diagrams of volume versus pressure for collapsible particulate materials in accordance with embodiments of the present techniques. In these diagrams, which may be referred to by reference numerals 700 and 702, the relationship of the volume versus the pressure for collapsible particles, such as the particles made of shape memory alloys, is described. In particular, a target response 704 may indicate the specified variation of the effective weight of drilling mud that is preferred for a well.

To provide the target response, as shown in diagram 700 of FIG. 7A, various different types of particles and fluids may be utilized. For instance, a compressible fluid, such as gas inside a flexible membrane, may be utilized to adjust the density of the drilling mud as described earlier.

For example, a shape memory alloy may also be utilized to vary the density of the drilling mud. Beneficially, with a shape memory alloy, the structure of the shape memory alloy particle may be varied and recovered based on the hydrostatic pressure and temperature within the wellbore, as shown by shape memory alloy responses 710a and 710b. This flexibility in the structure reduces the dependence on pressurized gas inside the shape memory alloy particle and expansion is achieved based on the shape recovery of the shape memory alloy particle. As a result, the effective weight of the drilling mud is adjusted based on the temperature and the pressure within the wellbore.

Further, as shown in diagram 702 of FIG. 7B, different shape memory alloy particles may also be utilized to closely approximate the target response 704 for a well. In this diagram 702, multiple shape memory alloy responses 712a-712i are utilized to vary the effective weight or density of the drilling mud. To adjust the collapse threshold for these shape memory alloy particles, various properties or parameters may be adjusted to provide specific responses to predefined volumes and pressures. For instance, the wall thickness, metal alloy material utilized, gas pressure within the shape memory alloy particle, shape or other similar properties may be modified to provide shape memory alloy particles that provide specific densities at predefined volumes and pressures. As such, these shape memory alloy particles may be configured to have different collapse thresholds to achieve the target variation of the volume with pressure.

Beneficially, the use of these shape memory alloy particles may provide more resiliency than other types of materials. The shape memory alloy particles may be more resistant to damage than polymer particles because metals are generally stronger than polymers. As a result, the shape memory alloy particles may be separated from the drilling mud at the surface and reused in an efficient manner.

Furthermore, the shape memory alloys provide additional flexibility in varying the density of the drilling mud. For instance, the shape memory alloys may be designed for specific applications by adjusting the transformation temperatures of the alloy, shape of the particles, and/or wall thickness based upon the anticipated downhole pressures and temperatures. This flexibility provides additional mechanisms for changing the architecture of a well, as noted above. It should also be noted that the hollow particles may be deformable to adjust between an initial and a deformed shape, which may also increase the density of the drilling mud.

Moreover, in an alternative embodiment, the variable density drilling mud may include particulate materials that are compressible (or collapsible) solid materials or objects. These compressible solid objects may function similar to the compressible hollow objects and have similar shapes, such as spheres, oblate or prolate spheroids, cylinders, pillows or any other suitable shape, for example. Again, the material utilized in these solid objects may be selected to achieve a specific compression in response to pressure changes, as discussed above. Beneficially, these particulate materials may be utilized to reach greater depths because the architecture of the casing strings may change and may justify the access to other resources, as noted above.

While the present techniques of the invention may be susceptible to various modifications and alternative forms, the exemplary embodiments discussed above have been shown by way of example. However, it should again be understood that the invention is not intended to be limited to the particular embodiments disclosed herein. Indeed, the present techniques of the invention are to cover all modifications, equivalents, and alternatives falling within the spirit and scope of the invention as defined by the following appended claims.

1. A drilling mud comprising: a compressible particulate material in the drilling mud wherein density of the drilling mud changes due to a volume change of the compressible particulate material in response to pressure or temperature changes and wherein the compressible particulate material is configured to maintain the density of the drilling mud between a pore pressure gradient and a fracture gradient based on the volume change of the compressible particulate material in response to pressure changes at certain depths.

2. The drilling mud of claim 1 wherein the compressible particulate material comprises a plurality of compressible hollow objects, wherein each of the compressible hollow objects has a hollow interior enclosed with a solid exterior shell.

3. The drilling mud of claim 2 wherein each of the plurality of compressible hollow objects contains pressurized gas in the hollow interior.

4. (canceled)

5. The drilling mud of claim 1 wherein the compressible particulate material is chosen from one of polymers, polymer composites, metal polymer laminates, metals, metal alloys, and any combination thereof.

6. The drilling mud of claim 2 wherein the initial internal pressure of each of the compressible hollow objects is selected based on a specific depth at which a transition in the compressibility is desired.

7. The drilling mud of claim 2 wherein a mixture of condensable and non-condensable gases is used to fill each of the compressible hollow objects.

8. The drilling mud of claim 2 wherein the solid exterior shell of each of the plurality of compressible hollow objects is made of material having a tensile strength that maintains an internal gas pressure up to a specified depth in a wellbore.

9. The drilling mud of claim 8 wherein the solid exterior shell is made from a material selected from one of metals, metal alloys, polymers, polymer composites, laminates of polymers, thin metallic films, and any combination thereof.

10. The drilling mud of claim 1 wherein initial properties of the drilling mud are configured to provide a composite mud gel point that suspends rock cuttings in an annulus of a wellbore during drilling operations and the viscosity of the drilling mud with the compressible particulate material is within pumpability requirements and remains between a pore pressure gradient and a fracture gradient.

11. The drilling mud of claim 2 wherein the solid exterior shell of each of the plurality of compressible hollow objects is a shape memory alloy material.

12. The drilling mud of claim 2 wherein the plurality of compressible hollow objects are filled with gases with large molecular volumes that possess intrinsically low diffusion rates.

13. The drilling mud of claim 2 wherein material of the solid exterior shell of the plurality of compressible hollow objects possesses intrinsically low permeability to enable reuse of the plurality of compressible hollow objects within a wellbore during drilling operations for a specific interval of a well.

14. The drilling mud of claim 2 further comprising compressible gas in the plurality of compressible hollow objects wherein at least a portion of the compressible gas is condensable and that liquefies with an increase in density and a corresponding decrease in volume at the temperature and pressure of the gas/liquid phase boundary of the condensable gas resulting in a decrease in internal volume of the compressible particulate material and a corresponding increase in effective mud density at the depth and temperature corresponding to the phase transition.

15. The drilling mud of claim 1 wherein the compressible participate material is a solid material.

16. The drilling mud of claim 1 wherein the compressible particulate material is a shape memory alloy.

17. The drilling mud of claim 16 wherein the shape memory alloy comprises Nickel-Titanium.

18. The drilling mud of claim 16 wherein the shape memory alloy comprises Copper-Aluminum-Zinc.

19. A method for varying drilling mud density comprising:
a) estimating a pore pressure gradient;
b) estimating a fracture gradient;
c) choosing a drilling mud with compressible materials wherein an effective mud weight of the drilling mud remains between the pore pressure gradient and the fracture gradient in at least one interval in a wellbore.

20. The method of claim 19 further comprising drilling the wellbore with the drilling mud.

21. The method of claim 20 further comprising confining the volume change to a plurality of objects mixed into the drilling mud and tailoring of the initial structure of the plurality of objects to achieve a desired rheology for the drilling mud with compressible materials, wherein mixing of the plurality of objects in the drilling mud results in a composite mud gel point that suspends rock cuttings in an annulus of the wellbore during drilling operations, and the viscosity of the drilling mud with compressible materials is within pumpability requirements and remains between the pore pressure gradient and the fracture gradient.

22. The method of claim 20 further comprising mixing a plurality of objects having different initial internal pressures and changing the volume fraction and distribution of the initial pressures to maintain drilling mud pressure between the pore pressure gradient and the fracture gradient in at least one interval of the wellbore.

23. The method of claim 20 further comprising confining the volume change to a plurality of objects mixed into the drilling mud, wherein the initial size of each of the plurality of objects in relation to the drilling mud rheology is configured to achieve a desired composite drilling mud rheology.

24. The method of claim 20 further comprising passing the compressible materials through mud pumps at the surface down a drill string, through a drill bit and through an annulus between the drill string and the wellbore.

25. The method of claim 20 further comprising separating the compressible materials from cuttings and reconstituting the drilling mud prior to re-injection into the wellbore.

26. The method of claim 20 further comprising shunting the compressible materials around a drill bit.

27. The method of claim 20 wherein the compressible materials are shunted around a drill bit by a downhole centrifugal separator disposed above a bottom hole assembly on a drill string with a side injection port to shunt the compressible materials into a return annulus.

28. The method of claim 20 wherein casings are added when the drilling mud pressure is not maintained between the pore pressure gradient and the fracture gradient.

29. The method of claim 28 wherein the compressible materials in the drilling mud are configured to provide a density change at a certain depth, and
wherein drilling mud pressure is maintained between the pore pressure gradient and the fracture gradient.

30. The method of claim 19 wherein the compressible materials comprise shape memory alloy particles.

31. The method of claim 30 wherein the shape memory alloy particles comprise Nickel-Titanium-Copper.

32. The method of claim 30 wherein the shape memory alloy particles comprise Copper-Aluminum-Nickel.

33. The method of claim 19 wherein the at least one interval in the wellbore comprises a first interval and a second interval and the compressible materials comprise a first shape memory alloy particles and a second shape memory alloy particles, wherein the first shape memory alloy particles and the second shape memory alloy particles are configured to have different collapse thresholds.

34. The method of claim 33 wherein the first shape memory alloy particles and the second shape memory alloy particles have different wall thickness to provide a variation in the density of the drilling mud.

35. The method of claim 33 wherein the first shape memory alloy particles and the second shape memory alloy particles comprise different metal alloy materials to provide a variation in the density of the drilling mud.

36. An apparatus for drilling a wellbore comprising,
a drill string with a bottom hole assembly (BHA) with a drill bit on the BHA,
means to pump and re-circulate variable density mud into a wellbore to maintain a variable density mud pressure in the wellbore between a pore pressure gradient and a fracture gradient.

37. The apparatus of claim 36 further comprising a down hole centrifugal separator above the BHA in the drill string with a side injection port above the BHA.

38. The apparatus of claim 37 wherein the means to pump variable density mud into the wellbore is a mud pump that pumps the variable density mud down the drill string through the drill bit and up an annulus between the drill string and the wellbore.

39. The apparatus of claim 36 wherein the variable density mud comprises compressible particulate materials, wherein density of the variable density mud changes due to a volume change of the compressible particulate materials in response to pressure changes at a certain depth.

40. The apparatus of claim 39 wherein the compressible particulate materials comprise compressible hollow solid materials.

41. The apparatus of claim 39 wherein the compressible particulate materials comprise compressible solid materials.

42. The apparatus of claim 39 wherein the compressible particulate materials comprise shape memory alloys.

43. The apparatus of claim 42 wherein the shape memory alloys comprise Nickel-Titanium.

44. The apparatus of claim 42 wherein the shape memory alloys comprise Copper-Aluminum-Zinc.

45. The apparatus of claim 42 wherein the shape memory alloys comprise Nickel-Titanium-Copper.

46. A drilling mud comprising:
a deformable object, wherein the deformable object is configured to:
adjust the density of the drilling mud when the deformable object changes shape; and
transform between an initial structure and a deformed structure as pressure changes on the deformable object.

47. The drilling mud of claim 46 wherein the deformable object is a compressible object.

48. The drilling mud of claim 47 wherein the compressible object comprises a plurality of shape memory alloys.

49. The drilling mud of claim 47 wherein the compressible object comprises a plurality of spherical objects.

50. The drilling mud of claim 47 wherein the compressible object comprises a plurality of compressible solid objects.

51. A drilling mud comprising:
a compressible object, the compressible object having an initial structure and a compressed structure, wherein the compressible object is configured to:
increase density of the drilling mud when the volume of the compressible object changes to the compressed structure at a first depth; and
decrease density of the drilling mud when the volume of the compressible object changes to the initial structure at a second depth.

52. The drilling mud of claim 51 wherein the compressible object comprises a plurality of shape memory alloys.

53. The drilling mud of claim 51 wherein the compressible object comprises a plurality of spherical objects.

54. The drilling mud of claim 51 wherein the compressible object comprises a plurality of compressible solid objects.

55. The drilling mud of claim 51 wherein the compressible object comprises a hollow interior enclosed with a solid exterior shell.

56. The drilling mud of claim 55 wherein the compressible object is partially filled with a liquid as part of the initial structure.

57. The drilling mud of claim 55 wherein the first depth and the second depth are different depths within a wellbore.

58. A drilling mud comprising:
a first plurality of compressible hollow objects wherein density of the drilling mud changes due to a volume change of the first plurality of compressible hollow objects at a first depth in response to pressure changes;
a second plurality of compressible hollow objects in the drilling mud wherein density of the drilling mud changes due to a volume change of the second plurality of compressible hollow objects at a second depth in response to pressure changes.

59. The drilling mud of claim 58 wherein each of the first plurality of compressible hollow objects and second plurality of compressible hollow objects has a hollow interior enclosed within a solid exterior shell.

60. The drilling mud of claim 59 wherein each of the first plurality of compressible hollow objects and second plurality of compressible hollow objects contains pressurized gas in the hollow interior.

61. The drilling mud of claim 59 wherein the solid exterior shell of each of the first plurality of compressible hollow objects and second plurality of compressible hollow objects is a shape memory alloy material.

62. The drilling mud of claim 58 wherein each of the first plurality of compressible hollow objects is configured to maintain the density of the drilling mud between a first pore pressure gradient and a first fracture gradient based on the volume change of the first plurality of compressible hollow objects in response to pressure changes at the first depth; and
wherein each of the second plurality of compressible hollow objects is configured to maintain the density of the drilling mud between a second pore pressure gradient and a second fracture gradient based on the volume change of the second plurality of compressible hollow objects in response to pressure changes at the second depth.

63. The drilling mud of claim 58 wherein each of the first plurality of compressible hollow objects and second plurality of compressible hollow objects comprises one of polymers, polymer composites, metal polymer laminates, metals, metal alloys and any combination thereof.

64. The drilling mud of claim 58 wherein a mixture of condensable and non-condensable gases is used to fill of each of the first plurality of compressible hollow objects and second plurality of compressible hollow objects.

65. The drilling mud of claim 58 wherein initial properties of the drilling mud are configured to provide a composite mud gel point that suspends rock cuttings in an annulus of a wellbore during drilling operations and the viscosity of the drilling mud with each of the first plurality of compressible hollow objects and second plurality of compressible hollow objects is within pumpability requirements.

66. The drilling mud of claim 58 wherein each of the first plurality of compressible hollow objects and second plurality of compressible hollow objects is filled with gases with large molecular volumes that possess intrinsically low diffusion rates.

67. The drilling mud of claim 58 wherein each of the first plurality of compressible hollow objects and second plurality of compressible hollow objects comprises solid materials.

68. The drilling mud of claim 58 wherein each of the first plurality of compressible hollow objects and second plurality of compressible hollow objects comprises shape memory alloys.

69. The drilling mud of claim 68 wherein the shape memory alloys comprise Nickel-Titanium.

70. The drilling mud of claim 68 wherein the shape memory alloys comprise Copper-Aluminum-Zinc.

71. The drilling mud of claim 58 wherein the first depth and the second depth are different depths within a wellbore.

72. A method for varying drilling mud density comprising:
estimating a first pore pressure gradient and a second pore pressure gradient within a wellbore;
estimating a first fracture gradient and a second fracture gradient within the wellbore;
selecting a drilling mud comprising a first plurality of compressible hollow objects and a second plurality of compressible hollow objects, wherein an effective mud weight of the drilling mud remains between the first pore pressure gradient and the first fracture gradient by a volume change of the first plurality of compressible hollow objects at a first depth and the effective mud weight of the drilling mud remains between the second pore pressure gradient and the second fracture gradient by a volume change of the second plurality of compressible hollow objects at a second depth.

73. The method of claim 72 further comprising drilling the wellbore with the drilling mud.

74. The method of claim 73 further comprising mixing of a first plurality of compressible hollow objects and a second plurality of compressible hollow objects in the drilling mud to achieve a desired rheology that results in a composite mud gel point that suspends rock cuttings in an annulus of the wellbore during drilling operations, and the viscosity of the drilling mud is within pumpability requirements.

75. The method of claim 72 wherein the first depth and the second depth are different depths within the wellbore.

76. The method of claim 72 further comprising passing the first plurality of compressible hollow objects and second plurality of compressible hollow objects through mud pumps at the surface down a drill string, through a drill bit and through an annulus between the drill string and the wellbore.

77. The method of claim 72 further comprising separating the first plurality of compressible hollow objects and second plurality of compressible hollow objects from cuttings and reconstituting the drilling mud prior to re-injection into the wellbore.

78. The method of claim 72 further comprising shunting the first plurality of compressible hollow objects and the second plurality of compressible hollow objects around a drill bit.

79. The method of claim 72 wherein the first plurality of compressible hollow objects and second plurality of compressible hollow objects are shunted around a drill bit by a downhole centrifugal separator disposed above a bottom hole assembly on a drill string with a side injection port to shunt the first plurality of compressible hollow objects and second plurality of compressible hollow objects into a return annulus.

80. The method of claim 72 wherein the first plurality of compressible hollow objects and second plurality of compressible hollow objects comprise shape memory alloy particles.

81. The method of claim 80 wherein the shape memory alloy particles comprise Nickel-Titanium-Copper.

82. The method of claim 80 wherein the shape memory alloy particles comprise Copper-Aluminum-Nickel.

83. The method of claim 72 wherein the first plurality of compressible hollow objects and second plurality of compressible hollow objects have different wall thickness to provide a variation in the density of the drilling mud.

84. The method of claim 72 wherein the first plurality of compressible hollow objects and second plurality of compressible hollow objects comprise different metal alloy materials to provide a variation in the density of the drilling mud.

85. A method of using a variable density fluid in a subterranean formation comprising introducing a fluid having a density that varies as a function of the pressure into the subterranean formation, wherein the fluid comprises a base fluid and a portion of elastic particles.

86. The method of claim 85 wherein the variable density fluid is used as a well fluid.

87. The method of claim 86 wherein the well fluid is a drilling fluid.

88. The method of claim 86 wherein the well fluid is selected from the group consisting of drilling fluids, compilation fluids, and stimulation fluids.

89. The method of claim 86 wherein the well fluid is drilling mud.

90. The method of claim 86 wherein the well fluid is selected from the group consisting of drilling muds, well cleanup fluids, workover fluids, spacer fluids, gravel pack fluids, acidizing fluids, and fracturing fluids.

91. The method of claim 85 further comprising the step of drilling, completing and/or stimulating a subterranean formation using the variable density fluid.

92. The method of claim 85 further comprising the step of producing a fluid from the subterranean formation.

93. The method of claim 92 wherein the fluid comprises oil, gas or a mixture thereof.

94. The method of claim 85 further comprising the step of drilling a borehole in the subterranean formation, wherein the method does not comprise a step of circulating a different fluid at any point during the drilling of the bore hole.

95. The method of claim 85 wherein the elastic particles have an isothermal compressibility factor in the range of from about 1.5×10⁻³ (1/psi) to about 1.5×10⁻⁹ (1/psi).

96. The method of claim 85 wherein the elastic particles have an isothermal compressibility factor in the range of from about 1.0×10⁻³ (1/psi) to about 5.0×10⁻⁵ (1/psi).

97. The method of claim 85 wherein the base fluid is present in the variable density fluid in an amount sufficient to form a pumpable fluid.

98. The method of claim 85 wherein the elastic particles further comprise an internal fluid.

99. The method of claim 98 wherein the internal fluid comprises air, nitrogen, carbon dioxide, propane, isobutane, normal butane, normal or branched pentane, ammonia, fluorinated hydrocarbons, hydrochlorofluorocarbons, argon, helium, or a mixture thereof.

100. The method of claim 78 wherein the internal fluid comprises a gas with a large molecular volume.

101. The method of claim 98 wherein the internal fluid comprises sulfur hexa-flouride.

102. The method of claim 85 wherein the elastic particles have a specific gravity in the range of from about 0.05 to about 0.99.

103. The method of claim 85 wherein a portion of the elastic particles can withstand pressures up to about 21,000 psi without crushing.

104. The method of claim 85 wherein a portion of the elastic particles can rebound to about their original size and shape when pressure is removed.

105. The method of claim 85 wherein a portion of the elastic particles can withstand temperatures up to about 500° F. without degrading.

106. The method of claim 85 wherein the elastic particles are substantially impermeable to a fluid present in the subterranean formation.

107. The method of claim 106 wherein the surface of a portion of the elastic particles is coated with a substantially impermeable material to render the elastic particles substantially impermeable to a fluid present in the subterranean formation.

108. The method of claim 107 wherein the material is hydrophilic or hydrophobic.

109. The method of claim 85 wherein the subterranean formation is located beneath the ocean floor, or on-shore.

110. The method of claim 85 wherein the variable density fluid has a density at sea level in the range of from about 4 lb/gallon to about 18 lb/gallon.

111. The method of claim 109 wherein the subterranean formation comprises a borehole, and wherein the density of the variable density fluid increases as the pressure in the borehole increases.

112. The method of claim 111 wherein the density of the drilling fluid in the borehole is in the range of from about 0.01% to about 300% higher than its density at sea level.

113. The method of claim 111 wherein the density of the variable density fluid in the borehole is sufficient to prevent fluid influx from a region of the subterranean formation adjacent to the borehole without fracturing a region of the formation.

114. The method of claim 111 wherein the subterranean formation is located beneath the ocean floor, and wherein the density of the variable density fluid decreases as the variable density fluid travels from the ocean floor to sea level.

115. The method of claim 85 wherein the variable density fluid further comprises a salt, a fluid loss additive, a shale swelling inhibitor, an emulsifier, a viscosifier, a pH control agent, a filtration control agent, or a fixed-density weighting agent.

116. The method of claim 85 wherein the variable density fluid further comprises a viscosifier.

117. The method of claim 85 wherein the variable density fluid is prepared by adding a portion of elastic particles to a fluid above sea level, at sea level, below sea level, or a combination thereof.

118. The method of claim 85 wherein the variable density fluid is prepared by adding a portion of elastic particles to a fluid at sea level, below sea level, or a combination thereof.

119. The method of claim 117 further comprising the step of drilling a borehole into the ocean floor, wherein a riser extends from the borehole to about sea level, and wherein a portion of the elastic particles are added to the fluid below sea level by injecting them into a riser.

120. The method of claim 118 further comprising the step of drilling a borehole into the ocean floor, wherein a riser extends from the borehole to about sea level, and wherein a portion of the elastic particles are added to the fluid below sea level by injecting them into a riser.

121. The method of claim 117 wherein the addition of the portion of elastic particles to the fluid reduces the density of the fluid.

122. The method of claim 118 wherein the addition of the portion of elastic particles to the fluid reduces the density of the fluid.

123. A method of avoiding the loss of circulation of a well fluid in a subterranean formation, comprising the step of adding to the well fluid a portion of elastic particles, the elastic particles being capable of varying in volume with pressure.

124. The method of claim 123 wherein the well fluid is a drilling fluid.

125. The method of claim 123 wherein the well fluid is selected from the group consisting of drilling fluids, completion fluids, and stimulation fluids.

126. The method of claim 123 wherein the well fluid is drilling mud.

127. The method of claim 123 wherein the well fluid is selected from the group consisting of drilling muds, well cleanup fluids, workover fluids, spacer fluids, gravel pack fluids, acidizing fluids, and fracturing fluids.

128. The method of claim 123 further comprising the step of drilling, completing and/or stimulating a subterranean formation using the variable density fluid.

129. The method of claim 123 wherein the elastic particles have a specific gravity in the range of from about 0.05 to about 0.99; and wherein the elastic particles have a compressibility factor in the range of from about 1.5×10⁻³ (1/psi) to about 1.5×10⁻⁹ (1/psi).

130. The method of claim 123 wherein the elastic particles have a specific gravity in the range of from about 0.05 to about 0.99; and wherein the elastic particles have a compressibility factor in the range of from about 1.0×10⁻³ (1/psi) to about 5.0×10⁻⁵ (1/psi).

131. The method of claim 123 wherein the well fluid is placed in a borehole within the subterranean formation, and wherein the density of the well fluid is sufficient to prevent fluid influx from a region of the subterranean formation adjacent to the borehole without fracturing a region of the formation.

132. The method of claim 123 further comprising the steps of: placing the well fluid in a borehole in the subterranean formation; permitting a portion of the well fluid to enter openings in a region of the subterranean formation in fluid communication with the borehole; and permitting the well fluid to seal the openings off from the borehole.

133. The method of claim 132 wherein the step of permitting the well fluid to seal the openings off from the borehole comprises permitting the elastic particles within the portion of the well fluid to expand upon entering the fractures such that the openings are sealed off from the borehole.

134. The method of claim 132 wherein the elastic particles have a specific gravity in the range of from about 0.05 to about 0.99; and wherein the elastic particles have a compressibility factor in the range of from about 1.5×10⁻³ (1/psi) to about 1.5×10⁻⁹ (1/psi).

135. The method of claim 132 wherein the elastic particles have a specific gravity in the range of from about 0.05 to about 0.99; and wherein the elastic particles have a compressibility factor in the range of from about 1.0×10⁻³ (1/psi) to about 5.0×10⁻⁵ (1/psi).

136. A method of using a variable density fluid in a subterranean formation comprising introducing a fluid having a density that varies as a function of the pressure into the subterranean formation, wherein the fluid comprises a base fluid and a portion of particles.

137. The method of claim 136 wherein the variable density fluid is used as a well fluid.

138. The method of claim 137 wherein the well fluid is a drilling fluid.

139. The method of claim 137 wherein the well fluid is selected from the group consisting of drilling fluids, compilation fluids, and stimulation fluids.

140. The method of claim 137 wherein the well fluid is drilling mud.

141. The method of claim 137 wherein the well fluid is selected from the group consisting of drilling muds, well cleanup fluids, workover fluids, spacer fluids, gravel pack fluids, acidizing fluids, and fracturing fluids.

142. The method of claim 136 further comprising the step of drilling, completing and/or stimulating a subterranean formation using the variable density fluid.

143. The method of claim 136 further comprising the step of producing a fluid from the subterranean formation.

144. The method of claim 143 wherein the fluid comprises oil, gas or a mixture thereof.

145. The method of claim 136 further comprising the step of drilling a borehole in the subterranean formation, wherein the method does not comprise a step of circulating a different fluid at any point during the drilling of the bore hole.

146. The method of claim 136 wherein the particles have an isothermal compressibility factor in the range of from about 1.5×10⁻³ (1/psi) to about 1.5×10⁻⁹ (1/psi).

147. The method of claim 136 wherein the particles have an isothermal compressibility factor in the range of from about 1.0×10⁻³ (1/psi) to about 5.0×10⁻⁵ (1/psi).

148. The method of claim 136 wherein the base fluid is present in the variable density fluid in an amount sufficient to form a pumpable fluid.

149. The method of claim 136 wherein the particles further comprise an internal fluid.

150. The method of claim 149 wherein the internal fluid comprises air, nitrogen, carbon dioxide, propane, isobutane, normal butane, normal or branched pentane, ammonia, fluorinated hydrocarbons, hydrochlorofluorocarbons, argon, helium, or a mixture thereof.

151. The method of claim 149 wherein the internal fluid comprises a gas with a large molecular volume.

152. The method of claim 149 wherein the internal fluid comprises sulfur hexa-flouride.

153. The method of claim 136 wherein the particles have a specific gravity in the range of from about 0.05 to about 0.99.

154. The method of claim 136 wherein a portion of the particles can withstand pressures up to about 21,000 psi without crushing.

155. The method of claim 136 wherein a portion of the particles can rebound to about their original size and shape when pressure is removed.

156. The method of claim 136 wherein a portion of the particles can withstand temperatures up to about 500° F. without degrading.

157. The method of claim 136 wherein the particles are substantially impermeable to a fluid present in the subterranean formation.

158. The method of claim 157 wherein the surface of a portion of the particles is coated with a substantially impermeable material to render the particles substantially impermeable to a fluid present in the subterranean formation.

159. The method of claim 158 wherein the material is hydrophilic or hydrophobic.

160. The method of claim 136 wherein the subterranean formation is located beneath the ocean floor, or on-shore.

161. The method of claim 136 wherein the variable density fluid has a density at sea level in the range of from about 4 lb/gallon to about 18 lb/gallon.

162. The method of claim 160 wherein the subterranean formation comprises a borehole, and wherein the density of the variable density fluid increases as the pressure in the borehole increases.

163. The method of claim 162 wherein the density of the drilling fluid in the borehole is in the range of from about 0.01% to about 300% higher than its density at sea level.

164. The method of claim 162 wherein the density of the variable density fluid in the borehole is sufficient to prevent fluid influx from a region of the subterranean formation adjacent to the borehole without fracturing a region of the formation.

165. The method of claim 162 wherein the subterranean formation is located beneath the ocean floor, and wherein the density of the variable density fluid decreases as the variable density fluid travels from the ocean floor to sea level.

166. The method of claim 136 wherein the variable density fluid further comprises a salt, a fluid loss additive, a shale swelling inhibitor, an emulsifier, a viscosifier, a pH control agent, a filtration control agent, or a fixed-density weighting agent.

167. The method of claim 136 wherein the variable density fluid further comprises a viscosifier.

168. The method of claim 136 wherein the variable density fluid is prepared by adding a portion of particles to a fluid above sea level, at sea level, below sea level, or a combination thereof.

169. The method of claim 136 wherein the variable density fluid is prepared by adding a portion of particles to a fluid at sea level, below sea level, or a combination thereof.

170. The method of claim 168 further comprising the step of drilling a borehole into the ocean floor, wherein a riser extends from the borehole to about sea level, and wherein a portion of the particles are added to the fluid below sea level by injecting them into a riser.

171. The method of claim 169 further comprising the step of drilling a borehole into the ocean floor, wherein a riser extends from the borehole to about sea level, and wherein a portion of the particles are added to the fluid below sea level by injecting them into a riser.

172. The method of claim 168 wherein the addition of the portion of particles to the fluid reduces the density of the fluid.

173. The method of claim 169 wherein the addition of the portion of particles to the fluid reduces the density of the fluid.

174. A method of avoiding the loss of circulation of a well fluid in a subterranean formation, comprising the step of adding to the well fluid a portion of particles, the particles being capable of varying in volume with pressure.

175. The method of claim 174 wherein the well fluid is a drilling fluid.

176. The method of claim 174 wherein the well fluid is selected from the group consisting of drilling fluids, completion fluids, and stimulation fluids.

177. The method of claim 174 wherein the well fluid is drilling mud.

178. The method of claim 174 wherein the well fluid is selected from the group consisting of drilling muds, well cleanup fluids, workover fluids, spacer fluids, gravel pack fluids, acidizing fluids, and fracturing fluids.

179. The method of claim 174 further comprising the step of drilling, completing and/or stimulating a subterranean formation using the variable density fluid.

180. The method of claim 174 wherein the particles have a specific gravity in the range of from about 0.05 to about 0.99; and wherein the particles have a compressibility factor in the range of from about 1.5×10⁻³ (1/psi) to about 1.5×10⁻⁹ (1/psi).

181. The method of claim 174 wherein the particles have a specific gravity in the range of from about 0.05 to about 0.99; and wherein the particles have a compressibility factor in the range of from about 1.0×10⁻³ (1/psi) to about 5.0×10⁻⁵ (1/psi).

182. The method of claim 174 wherein the well fluid is placed in a borehole within the subterranean formation, and wherein the density of the well fluid is sufficient to prevent fluid influx from a region of the subterranean formation adjacent to the borehole without fracturing a region of the formation.

183. The method of claim 174 further comprising the steps of: placing the well fluid in a borehole in the subterranean formation; permitting a portion of the well fluid to enter openings in a region of the subterranean formation in fluid communication with the borehole; and permitting the well fluid to seal the openings off from the borehole.

184. The method of claim 183 wherein the step of permitting the well fluid to seal the openings off from the borehole comprises permitting the elastic particles within the portion of the well fluid to expand upon entering the fractures such that the openings are sealed off from the borehole.

185. The method of claim 183 wherein the particles have a specific gravity in the range of from about 0.05 to about 0.99; and wherein the elastic particles have a compressibility factor in the range of from about 1.5×10⁻³ (1/psi) to about 1.5×10⁻⁹ (1/psi).

186. The method of claim 183 wherein the particles have a specific gravity in the range of from about 0.05 to about 0.99; and wherein the elastic particles have a compressibility factor in the range of from about 1.0×10⁻³ (1/psi) to about 5.0×10⁻⁵ (1/psi).

187. A method of drilling, completing and/or stimulating a subterranean formation using a variable density fluid comprising the steps of: introducing a fluid having a density that varies as a function of pressure into the subterranean formation, wherein the fluid comprises a base fluid and a portion of elastic particles; the elastic particles have an isothermal compressibility factor in the range of from about 1.5×10⁻³ (1/psi) to about 1.5×10⁻⁹ (1/psi); and drilling, completing and/or stimulating a subterranean formation using the variable density fluid.

188. The method of claim 187 wherein the elastic particles have a specific gravity in the range of from about 0.05 to about 0.99.

189. A fluid having a density that varies as a function of pressure comprising: a base fluid; and a portion of elastic particles, the elastic particles having an isothermal compressibility factor in the range of from about 1.5×10⁻³ (1/psi) to about 1.5×10⁻⁹ (1/psi).

190. The fluid of claim 189 wherein the fluid is selected from the group consisting of drilling fluids, completion fluids, and stimulation fluids.

191. The fluid of claim 189 wherein the fluid is a drilling fluid.

192. The fluid of claim 189 wherein the fluid is selected from the group consisting of drilling muds, well cleanup fluids, workover fluids, spacer fluids, gravel pack fluids, acidizing fluids, and fracturing fluids.

193. The fluid of claim 189 wherein the fluid is drilling mud.

194. The fluid of claim 189 wherein the base fluid is present in the fluid in an amount sufficient to form a pumpable well fluid.

195. The fluid of claim 189 wherein the elastic particles have a specific gravity in the range of from about 0.05 to about 0.99.

196. The fluid of claim 189 wherein a portion of the elastic particles further comprise an internal fluid.

197. The fluid of claim 196 wherein the internal fluid comprises air, nitrogen, carbon dioxide, propane, isobutane, normal butane, normal or branched pentane, ammonia, fluorinated hydrocarbons, hydrochlorofluorocarbons, argon, helium, or a mixture thereof.

198. The fluid of claim 196 wherein the internal fluid comprises a gas with a large molecular volume.

199. The fluid of claim 196 wherein the internal fluid comprises sulfur hexa-flouride.

200. The fluid of claim 189 having a density at sea level in the range of from about 4 lb/gallon to about 18 lb/gallon.

201. The fluid of claim 189 wherein a portion of the elastic particles can withstand a pressure up to about 21,000 psi without crushing.

202. The fluid of claim 189 wherein a portion of the elastic particles can rebound to about their original size and shape when pressure is removed.

203. The fluid of claim 189 wherein a portion of the elastic particles can withstand temperatures up to about 500° F. without degrading.

204. The fluid of claim 189 wherein a portion of the elastic particles are substantially impermeable to a fluid present in a subterranean borehole.

205. The fluid of claim 204 wherein the surface of a portion of the elastic particles is coated with a substantially impermeable material to render the elastic particles substantially impermeable to a fluid present in a subterranean borehole.

206. The fluid of claim 205 wherein the material is hydrophilic or hydrophobic.

207. The fluid of claim 189 having a density that increases as the pressure in a subterranean borehole increases.

208. The fluid of claim 207 wherein the density of the fluid in the borehole is in the range of from about 0.01% to about 300% higher than its density at sea level.

209. The fluid of claim 207 wherein the subterranean borehole is located beneath the ocean floor, and wherein the density of the fluid decreases as the fluid travels from the subterranean borehole up to sea level.

210. The fluid of claim 189 further comprising a salt, a fluid loss additive, a shale swelling inhibitor, an emulsifier, a viscosifier, a filtration control agent, a pH control agent, a fixed-density weighting agent, or a mixture thereof.

211. The fluid of claim 189 further comprising a viscosifier.

212. A method of drilling, completing and/or stimulating a subterranean formation using a variable density fluid comprising the steps of: introducing a fluid having a density that varies as a function of pressure into the subterranean formation, wherein the fluid comprises a base fluid and a portion of elastic particles; the elastic particles have an isothermal compressibility factor in the range of from about 1.0×10⁻³ (1/psi) to about 5.0×10⁻⁵ (1/psi); and drilling, completing and/or stimulating a subterranean formation using the variable density fluid.

213. The method of claim 212 wherein the elastic particles have a specific gravity in the range of from about 0.05 to about 0.99.

214. A fluid having a density that varies as a function of pressure comprising: a base fluid; and a portion of elastic particles, the elastic particles having an isothermal compressibility factor in the range of from about 1.0×10⁻³ (1/psi) to about 5×10⁻⁵ (1/psi).

215. The fluid of claim 214 wherein the fluid is selected from the group consisting of drilling fluids, completion fluids, and stimulation fluids.

216. The fluid of claim 214 wherein the fluid is a drilling fluid.

217. The fluid of claim 214 wherein the fluid is selected from the group consisting of drilling muds, well cleanup fluids, workover fluids, spacer fluids, gravel pack fluids, acidizing fluids, and fracturing fluids.

218. The fluid of claim 214 wherein the fluid is drilling mud.

219. The fluid of claim 214 wherein the base fluid is present in the fluid in an amount sufficient to form a pumpable well fluid.

220. The fluid of claim 214 wherein the elastic particles have a specific gravity in the range of from about 0.05 to about 0.99.

221. The fluid of claim 214 wherein a portion of the elastic particles further comprise an internal fluid.

222. The fluid of claim 221 wherein the internal fluid comprises air, nitrogen, carbon dioxide, propane, isobutane, normal butane, normal or branched pentane, ammonia, fluorinated hydrocarbons, hydrochlorofluorocarbons, argon, helium, or a mixture thereof.

223. The fluid of claim 221 wherein the internal fluid comprises a gas with a large molecular volume.

224. The fluid of claim 221 wherein the internal fluid comprises sulfur hexa-flouride.

225. The fluid of claim 214 having a density at sea level in the range of from about 4 lb/gallon to about 18 lb/gallon.

226. The fluid of claim 214 wherein a portion of the elastic particles can withstand a pressure up to about 21,000 psi without crushing.

227. The fluid of claim 214 wherein a portion of the elastic particles can rebound to about their original size and shape when pressure is removed.

228. The fluid of claim 214 wherein a portion of the elastic particles can withstand temperatures up to about 500° F. without degrading.

229. The fluid of claim 214 wherein a portion of the elastic particles are substantially impermeable to a fluid present in a subterranean borehole.

230. The fluid of claim 229 wherein the surface of a portion of the elastic particles is coated with a substantially impermeable material to render the elastic particles substantially impermeable to a fluid present in a subterranean borehole.

231. The fluid of claim 230 wherein the material is hydrophilic or hydrophobic.

232. The fluid of claim 214 having a density that increases as the pressure in a subterranean borehole increases.

233. The fluid of claim 232 wherein the density of the fluid in the borehole is in the range of from about 0.01% to about 300% higher than its density at sea level.

234. The fluid of claim 232 wherein the subterranean borehole is located beneath the ocean floor, and wherein the density of the fluid decreases as the fluid travels from the subterranean borehole up to sea level.

235. The fluid of claim 214 further comprising a salt, a fluid loss additive, a shale swelling inhibitor, an emulsifier, a viscosifier, a filtration control agent, a pH control agent, a fixed-density weighting agent, or a mixture thereof.

236. The fluid of claim 214 further comprising a viscosifier.

237. A method of drilling, completing and/or stimulating a subterranean formation using a variable density fluid comprising the steps of: introducing a fluid having a density that varies as a function of pressure into the subterranean formation, wherein the fluid comprises a base fluid and a portion of particles; the particles have an isothermal compressibility factor in the range of from about 1.5×10⁻³ (1/psi) to about 1.5×10⁻⁹ (1/psi); and drilling, completing and/or stimulating a subterranean formation using the variable density fluid.

238. The method of claim 237 wherein the particles have a specific gravity in the range of from about 0.05 to about 0.99.

239. A fluid having a density that varies as a function of pressure comprising: a base fluid; and a portion of particles, the particles having an isothermal compressibility factor in the range of from about 1.5×10⁻³ (1/psi) to about 1.5×10⁻⁹ (1/psi).

240. The fluid of claim 239 wherein the fluid is selected from the group consisting of drilling fluids, completion fluids, and stimulation fluids.

241. The fluid of claim 239 wherein the fluid is a drilling fluid.

242. The fluid of claim 239 wherein the fluid is selected from the group consisting of drilling muds, well cleanup fluids, workover fluids, spacer fluids, gravel pack fluids, acidizing fluids, and fracturing fluids.

243. The fluid of claim 239 wherein the fluid is drilling mud.

244. The fluid of claim 239 wherein the base fluid is present in the fluid in an amount sufficient to form a pumpable well fluid.

245. The fluid of claim 239 wherein the particles have a specific gravity in the range of from about 0.05 to about 0.99.

246. The fluid of claim 239 wherein a portion of the particles further comprise an internal fluid.

247. The fluid of claim 246 wherein the internal fluid comprises air, nitrogen, carbon dioxide, propane, isobutane, normal butane, normal or branched pentane, ammonia, fluorinated hydrocarbons, hydrochlorofluorocarbons, argon, helium, or a mixture thereof.

248. The fluid of claim 246 wherein the internal fluid comprises a gas with a large molecular volume.

249. The fluid of claim 246 wherein the internal fluid comprises sulfur hexa-flouride.

250. The fluid of claim 239 having a density at sea level in the range of from about 4 lb/gallon to about 18 lb/gallon.

251. The fluid of claim 239 wherein a portion of the particles can withstand a pressure up to about 21,000 psi without crushing.

252. The fluid of claim 239 wherein a portion of the particles can rebound to about their original size and shape when pressure is removed.

253. The fluid of claim 239 wherein a portion of the particles can withstand temperatures up to about 500° F. without degrading.

254. The fluid of claim 239 wherein a portion of the particles are substantially impermeable to a fluid present in a subterranean borehole.

255. The fluid of claim 254 wherein the surface of a portion of the particles is coated with a substantially impermeable material to render the particles substantially impermeable to a fluid present in a subterranean borehole.

256. The fluid of claim 255 wherein the material is hydrophilic or hydrophobic.

257. The fluid of claim 239 having a density that increases as the pressure in a subterranean borehole increases.

258. The fluid of claim 257 herein the density of the fluid in the borehole is in the range of from about 0.01% to about 300% higher than its density at sea level.

259. The fluid of claim 257 wherein the subterranean borehole is located beneath the ocean floor, and wherein the density of the fluid decreases as the fluid travels from the subterranean borehole up to sea level.

260. The fluid of claim 239 further comprising a salt, a fluid loss additive, a shale swelling inhibitor, an emulsifier, a viscosifier, a filtration control agent, a pH control agent, a fixed-density weighting agent, or a mixture thereof.

261. The fluid of claim 239 further comprising a viscosifier.

262. A method of drilling, completing and/or stimulating a subterranean formation using a variable density fluid comprising the steps of: introducing a fluid having a density that varies as a function of pressure into the subterranean formation, wherein the fluid comprises a base fluid and a portion of particles; the particles have an isothermal compressibility factor in the range of from about 1.0×10⁻³ (1/psi) to about 5.0×10⁻⁵ (1/psi); and drilling, completing and/or stimulating a subterranean formation using the variable density fluid.

263. The method of claim 262 wherein the particles have a specific gravity in the range of from about 0.05 to about 0.99.

264. A fluid having a density that varies as a function of pressure comprising: a base fluid; and a portion of particles, the particles having an isothermal compressibility factor in the range of from about 1.0×10⁻³ (1/psi) to about 5×10⁻⁵ (1/psi).

265. The fluid of claim 264 wherein the fluid is selected from the group consisting of drilling fluids, completion fluids, and stimulation fluids.

266. The fluid of claim 264 wherein the fluid is a drilling fluid.

267. The fluid of claim 264 wherein the fluid is selected from the group consisting of drilling muds, well cleanup fluids, workover fluids, spacer fluids, gravel pack fluids, acidizing fluids, and fracturing fluids.

268. The fluid of claim 264 wherein the fluid is drilling mud.

269. The fluid of claim 264 wherein the base fluid is present in the fluid in an amount sufficient to form a pumpable well fluid.

270. The fluid of claim 264 wherein the particles have a specific gravity in the range of from about 0.05 to about 0.99.

271. The fluid of claim 264 wherein a portion of the particles further comprise an internal fluid.

272. The fluid of claim 271 wherein the internal fluid comprises air, nitrogen, carbon dioxide, propane, isobutane, normal butane, normal or branched pentane, ammonia, fluorinated hydrocarbons, hydrochlorofluorocarbons, argon, helium, or a mixture thereof.

273. The fluid of claim 271 wherein the internal fluid comprises a gas with a large molecular volume.

274. The fluid of claim 271 wherein the internal fluid comprises sulfur hexa-flouride.

275. The fluid of claim 264 having a density at sea level in the range of from about 4 lb/gallon to about 18 lb/gallon.

276. The fluid of claim 264 wherein a portion of the particles can withstand a pressure up to about 21,000 psi without crushing.

277. The fluid of claim 264 wherein a portion of the particles can rebound to about their original size and shape when pressure is removed.

278. The fluid of claim 264 wherein a portion of the particles can withstand temperatures up to about 500° F. without degrading.

279. The fluid of claim 264 wherein a portion of the particles are substantially impermeable to a fluid present in a subterranean borehole.

280. The fluid of claim 279 wherein the surface of a portion of the particles is coated with a substantially impermeable material to render the particles substantially impermeable to a fluid present in a subterranean borehole.

281. The fluid of claim 280 wherein the material is hydrophilic or hydrophobic.

282. The fluid of claim 264 having a density that increases as the pressure in a subterranean borehole increases.

283. The fluid of claim 282 herein the density of the fluid in the borehole is in the range of from about 0.01% to about 300% higher than its density at sea level.

284. The fluid of claim 282 wherein the subterranean borehole is located beneath the ocean floor, and wherein the density of the fluid decreases as the fluid travels from the subterranean borehole up to sea level.

285. The fluid of claim 264 further comprising a salt, a fluid loss additive, a shale swelling inhibitor, an emulsifier, a viscosifier, a filtration control agent, a pH control agent, a fixed-density weighting agent, or a mixture thereof.

286. The fluid of claim 264 further comprising a viscosifier.

287. A method of using a treatment fluid in a subterranean formation comprising introducing a treatment fluid having a density that varies as a function of pressure into a subterranean formation, wherein the treatment fluid comprises a base fluid and a portion of variable pressure weighting material particles.

288. The method of claim 287 wherein the treatment fluid is used as a well fluid.

289. The method of claim 288 wherein the well fluid is a drilling fluid.

290. The method of claim 288 wherein the well fluid is a drilling mud.

291. The method of claim 290 further comprising the step of drilling using the treatment fluid.

292. The method of claim 291 further comprising the step of producing a fluid from the subterranean formation.

293. The method of claim 292 wherein the fluid comprises oil, gas, or a mixture thereof.

294. The method of claim 287 wherein the treatment fluid has a density at sea level in the range of from about 9 lb/gallon to about 12 lb/gallon.

295. The method of claim 287 wherein the base fluid is oil, water, or a mixture thereof.

296. The method of claim 287 wherein the portion of variable pressure weighting material particles is present in the treatment fluid in an amount of about 50% by volume.

297. The method of claim 287 wherein the variable pressure weighting material particle further comprises a compressible fluid.

298. The method of claim 297 wherein the compressible fluid comprises air, propane, ammonia, fluorinated hydrocarbon refrigerants, nitrogen, carbon dioxide, argon or a mixture thereof.

299. The method of claim 297 wherein the compressible fluid comprises a gas having a large molecular volume.

300. The method of claim 299 wherein the compressible fluid comprises sulfur hexafluoride.

301. The method of claim 287 wherein a portion of the variable pressure weighting material particles can withstand the pressure at a depth of 22,000 feet without crushing.

302. The method of claim 287 wherein a portion of the variable pressure weighting material particles comprise a material having a yield strength of at least 27.6 MPa.

303. The method of claim 301 wherein a portion of the variable pressure weighting material particles can rebound to about their original size and shape when pressure is removed.

304. The method of claim 302 wherein a portion of the variable pressure weighting material particles can rebound to about their original size and shape when pressure is removed.

305. The method of claim 287 wherein a portion of the variable pressure weighting material particles can withstand temperatures up to about 500 degree F. without degrading.

306. The method of claim 287 wherein the subterranean formation comprises a borehole, and wherein the density of the treatment fluid increases as the pressure in the bore hole increases.

307. The method of claim 306 wherein the density of the treatment fluid in the bore hole is up to about 50% higher than its density at sea level.

308. The method of claim 287 wherein the subterranean formation is located beneath the ocean floor.

309. The method of claim 308 wherein the density of the treatment fluid decreases as the treatment fluid travels from the ocean floor to sea level.

310. The method of claim 287 wherein the treatment fluid further comprises a fluid loss additive, a viscosifier, or a fixed-density weighting agent.

311. The method of claim 287 wherein the variable pressure weighting material particle comprises a material selected from the group consisting of: a plastic, an elastomer, and a metal.

312. The method of claim 311 wherein the metal is a memory metal.

313. The method of claim 311 wherein the metal is elastically deformable.

314. The method of claim 311 wherein the metal is a shape memory alloy.

315. The method of claim 306 wherein the density of the treatment fluid in the borehole is sufficient to prevent kicks without fracturing a region of the subterranean formation adjacent to the borehole.

316. A method of preparing a variable pressure weighting material particle comprising the step of pressurizing and sealing a cylinder formed from an elastically deformable material.

317. A variable density treatment fluid comprising:
a base fluid; and
a portion of variable pressure weighting material particles.

318. The treatment fluid of claim 317 wherein the base fluid is water, oil, or a mixture thereof.

319. The treatment fluid of claim 317 wherein a portion of the variable pressure weighting material particles further comprise a compressible fluid.

320. The treatment fluid of claim 319 wherein the compressible fluid comprises carbon dioxide.

321. The treatment fluid of claim 319 wherein the compressible fluid comprises a gas having a large molecular volume.

322. The treatment fluid of claim 321 wherein the compressible fluid comprises sulfur hexafluoride.

323. The treatment fluid of claim 317 having a density at sea level in the range of from about 9 lb/gallon to about 12 lb/gallon.

324. The treatment fluid of claim 317 wherein the portion of variable pressure weighting material particles is present in the treatment fluid in an amount of about 50%.

325. The treatment fluid of claim 317 wherein a portion of the variable pressure weighting material particles can withstand the pressure at a depth of 22,000 feet without crushing.

326. The treatment fluid of claim 317 wherein a portion of the variable pressure weighting material particles comprise a material having a yield strength of at least 27.6 MPa.

327. The treatment fluid of claim 325 wherein a portion of the variable pressure weighting material particles can rebound to about their original size and shape when the pressure is removed.

328. The treatment fluid of claim 326 wherein a portion of the variable pressure weighting material particles can rebound to about their original size and shape when the pressure is removed.

329. The treatment fluid of claim 317 wherein a portion of the variable pressure weighting material particles can withstand temperatures up to about 500 degrees F. without degrading.

330. The treatment fluid of claim 317 wherein the density of the treatment fluid increases as the pressure in a subterranean bore hole increases.

331. The treatment fluid of claim 330 wherein the density of the treatment fluid in the bore hole is up to about 50% higher than its density at sea level.

332. The treatment fluid of claim 330 wherein the bore hole is located beneath the ocean floor.

333. The treatment fluid of claim 332 wherein the density of the treatment fluid decreases as the treatment fluid travels from the bore hole up to sea level.

334. The treatment fluid of claim 317 further comprising a fluid loss additive, a viscosifier, or a fixed-density weighting agent.

335. The treatment fluid of claim 317 wherein the variable pressure weighting material particle comprises a material selected from the group consisting of: a plastic, an elastomer and a metal.

336. The treatment fluid of claim 335 wherein the metal is a memory metal.

337. The treatment fluid of claim 335 wherein the metal is elastically deformable.

338. The treatment fluid of claim 335 wherein the metal is a shape memory allow.

339. The treatment fluid of claim 330 having a density sufficient to prevent kicks without fracturing a region of the subterranean formation adjacent to the borehole

340. A variable pressure weighting material particle comprising a hollow, elastically deformable particle.

341. The variable pressure weighting material particle of claim 340 further comprising a compressible fluid.

342. The variable pressure weighting material particle of claim 341 wherein the compressible fluid comprises air, propane, ammonia, fluorinated hydrocarbon refrigerants, nitrogen, carbon dioxide, argon or a mixture thereof.

343. The variable pressure weighting material particle claim 341 wherein the compressible fluid comprises a gas having a large molecular volume.

344. The variable pressure weighting material particle of claim 343 wherein the compressible fluid comprises sulfur hexafluoride.

345. The variable pressure weighting material particle of claim 340 being capable of withstanding the pressure at a depth of 22,000 feet without crushing.

346. The variable pressure weighting material particle of claim 340 comprising a material having a yield strength of at least 27.6 MPa.

347. The variable pressure weighting material particle of claim 345 being capable of rebounding to about its original size and shape when pressure is removed.

348. The variable pressure weighting material particle of claim 346 being capable of rebounding to about its original size and shape when pressure is removed.

349. The variable pressure weighting material particle of claim 340 being capable of withstanding temperatures up to about 500 degrees F. without degrading.

350. The variable pressure weighting material particle of claim 340 having an internal pressure up to 13.8 MPa.

351. The variable pressure weighting material particle of claim 340 having an internal pressure up to 2,250 psi.

352. The variable pressure weighting material particle of claim 340 comprising a material selected from the group consisting of: a plastic, an elastomer, and a metal.

353. The variable pressure weighting material particle of claim 352 wherein the metal is a memory metal.

354. The variable pressure weighting material particle of claim 352 wherein the metal is elastically deformable.

355. The variable pressure weighting material particle of claim 352 wherein the metal is a shape memory alloy.

356. The variable pressure weighting material particle of claim 340 having an external diameter small enough to be circulated through equipment used in subterranean formation well bore treatment without fouling such equipment.

357. The variable pressure weighting material particle of claim 353 having an external diameter of about 1.0 mm.

358. The variable pressure weighting material particle of claim 354 having an external diameter of about 1.0 mm.

359. The variable pressure weighting material particle of claim 355 having an external diameter of about 1.0 mm.

360. The variable pressure weighting material particle of claim 356 having an external diameter of about 1.0 mm.
